(19) United States
(12) Patent Application Publication
(10) Pub. No.: US 2010/0030994 A1
(43) Pub. Date: Feb. 4, 2010

(54) METHODS, SYSTEMS, AND COMPUTER READABLE MEDIA FOR MEMORY ALLOCATION AND DEALLOCATION

(76) Inventor: Luis F. Guzman, Morrisville, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/339,964

(22) Filed: Dec. 19, 2008

Related U.S. Application Data
(60) Provisional application No. 61/085,672, filed on Aug. 1, 2008.

(51) Int. Cl. G06F 12/02

(52) U.S. Cl. 711/173; 711/E12.002

(57) ABSTRACT

Methods, systems, and computer readable media for memory allocation and de-allocation are disclosed. According to one aspect, a method for allocation and de-allocation of memory includes dividing a memory space into a plurality of records of fixed size and maintaining an allocation map for indicating, for each record in the memory space, whether the record is allocated or unallocated. The method also includes maintaining a set of lists of unallocated blocks, where a block is a group of contiguous records, where the size of a block is the number of contiguous records in the block, and where each list lists unallocated blocks of a particular size. The method also includes processing requests for allocation and de-allocation of memory. Processing a request for memory allocation includes using the set of lists to find an unallocated block of the smallest size that is equal to or greater than the amount of memory requested to be allocated. Processing a request for memory de-allocation includes using the allocation map to combine the deallocated memory block with an unallocated block contiguous to the deallocated memory block and add the combined blocks to the list indicating unallocated blocks of the size of the combined memory blocks.

### RELATED APPLICATIONS

This application claims the benefit of U.S. Provisional Patent Application Ser. No. 61/085,672, filed Aug. 1, 2008; the disclosure of which is incorporated herein by reference in its entirety.

### TECHNICAL FIELD

The subject matter described herein relates to methods and systems for allocating memory. More particularly, the subject matter described herein relates to methods, systems, and computer readable media for memory allocation and deallocation.

### BACKGROUND

The operation of a telecommunications network often requires the performance of what are commonly referred to as database-like functions, in which one piece of information, herein referred to as a “key”, is used to find another piece of information, herein referred to as a “value”. A database may be used to store the (key,value) association, but tables and other data structures may be used as well—thus the term “database-like”.

For example, number portability allows a telephone subscriber to change geographic location, service, or network provider but still keep the subscriber's original directory number. Such as subscriber is referred to as a “ported” subscriber. A call made to a ported subscriber's original directory number must be redirected towards the switch that is now servicing that subscriber. In this example, the subscriber's original number is the key and the address of the switch is the value in a (key,value) relationship.

Implementation of a relational database, however, may require large processor and memory resources, and because a telecommunications network may include many hundreds or even thousands of nodes, each of which may perform one or more database-like functions, the cumulative cost of these processor and memory resources can be significant. To curtail costs, a node may contain a limited amount of memory. For this reason, fast and efficient use of limited memory resources is highly desirable.

In the case of database-like functions especially, memory may be continually allocated, deallocated, and re-allocated according to the demands of the database-like function, as records are added, modified, deleted, merged, and so on. This process can lead to fragmentation of memory, a condition where the unallocated memory is distributed across the memory space in portions or fragments. In systems where memory must be allocated in contiguous sections, a request for an allocation of memory of size R may fail if there is no fragment available of size greater than or equal to R, even though the total amount of unallocated space in the memory may be greater than (or even many times greater than) R. For this reason, allocation and de-allocation, and their potential contribution to fragmentation, can be a crucial component of memory management.

Typically, however, a system that makes efficient use of memory tends to be complex, requiring more processing capability, while a system that implements a simple allocation method tends to allocate memory inefficiently and contribute to fragmentation. Accordingly, in light of these disadvantages associated with the tradeoff between efficiency and complexity, there exists a need for a method of allocating and de-allocating memory that is simple, efficient, and incurs minimal fragmentation. Specifically, there exists a need for methods, systems, and computer readable media for memory allocation and de-allocation.

### SUMMARY

According to one aspect, a method for allocation and de-allocation of memory includes dividing a memory space into a plurality of records of fixed size and maintaining an allocation map for indicating, for each record in the memory space, whether the record is allocated or unallocated. The method also includes maintaining a set of lists of unallocated blocks, where a block is a group of contiguous records, where the size of a block is the number of contiguous records in the block, and where each list lists unallocated blocks of a particular size. The method also includes processing requests for allocation and de-allocation of memory. Processing a request for memory allocation includes using the set of lists to find an unallocated block of the smallest size that is equal to or greater than the amount of memory requested to be allocated. Processing a request for memory de-allocation includes using the allocation map to combine the deallocated memory block with an unallocated block contiguous to the deallocated memory block and add the combined blocks to the list indicating unallocated blocks of the size of the combined memory blocks.

According to another aspect, the subject matter described herein includes a system for allocation and de-allocation of memory. The system includes a memory organized into a plurality of records of fixed size and an allocation map for indicating, for each record in the memory, whether the record is allocated or unallocated. The system also includes a set of lists of unallocated blocks, where a block is a group of contiguous records, where the size of a block is the number of contiguous records in the block, and where each list lists unallocated blocks of a particular size. The system also includes an allocation module for allocating and de-allocating memory. Allocating memory includes using the set of lists to find an unallocated block of the smallest size that is equal to or greater than the amount of memory requested. De-allocating memory includes using the allocation map to combine the deallocated memory block of a first size with an unallocated block of a second size and contiguous to the deallocated memory block to form an unallocated block of a third size and adding the unallocated block of the third size to the list indicating unallocated blocks of the third size.

According to another aspect, the subject matter described herein includes a memory manager for allocating and de-allocating memory. The memory manager includes an allocation map for indicating, for each record in a memory that is organized into records of a fixed size, whether the record is allocated or unallocated. The memory manager also includes a set of lists for listing unallocated blocks of particular sizes, where a block is a group of contiguous records and where the size of the block is the number of contiguous records in the block. The memory manager also includes an allocation module for allocating and de-allocating memory. Allocation includes using the set of lists to find an unallocated block of the smallest size that is equal to or greater than the size requested. De-allocation includes using the allocation map to combine the deallocated memory block with an unallocated block contiguous to the deallocated memory block and add the combined blocks to the list indicating unallocated blocks of the size of the combined memory blocks.

The subject matter described herein for memory allocation and deallocation may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a computer readable medium having stored thereon computer executable instructions that when executed by the processor of a computer perform steps.

Exemplary computer readable media suitable for implementing the subject matter described herein include disk memory devices, chip memory devices, programmable logic devices, and application specific integrated circuits. In addition, a computer program product that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a block diagram illustrating a system for allocation and de-allocation of memory according to an embodiment of the subject matter described herein; and

FIG. 2 is a flow chart illustrating an exemplary process for allocation and de-allocation of memory according to an embodiment of the subject matter described herein.

### DETAILED DESCRIPTION

In accordance with the subject matter disclosed herein, systems, methods, and computer readable medium are provided for memory allocation and de-allocation of discrete memory blocks varying in size from 1 to N records. Memory fragmentation is reduced by combining adjacent free memory blocks into a larger block as memory is deallocated.

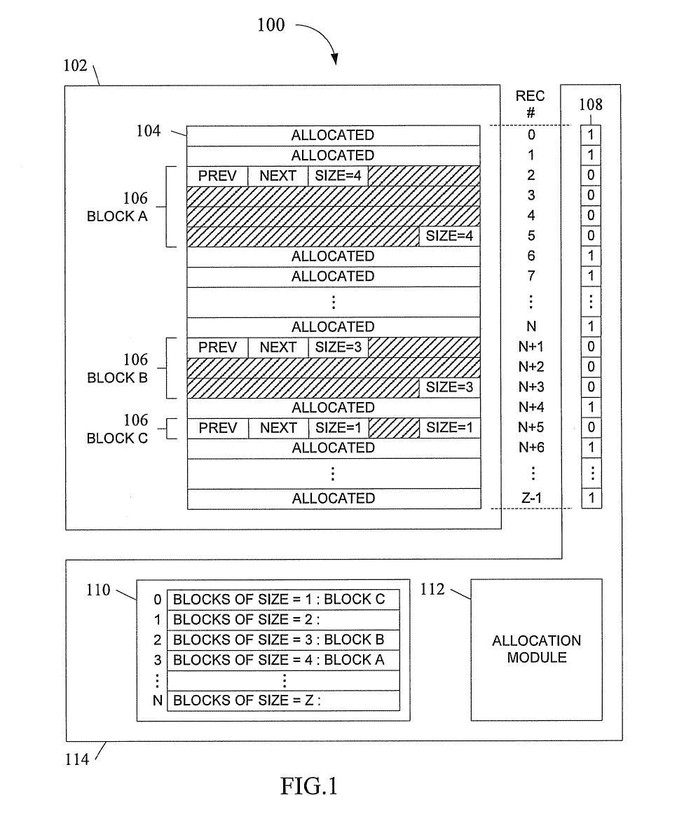

FIG. 1 is a block diagram illustrating a system for allocation and de-allocation of memory according to an embodiment of the subject matter described herein. In one embodiment, system 100 includes a memory 102, which is organized into records 104 of fixed size and may be further organized into one or more blocks 106 that contain one or more contiguous records 104. In one embodiment, memory is allocated and deallocated in blocks 106.

An allocation map 108 may be used to indicate the status of each record 104 in memory 102, i.e., whether the record is allocated or unallocated. It is not necessary for allocation map 108 to keep information indicating a record's membership within a block, and in the embodiment illustrated in FIG. 1, allocation map 108 does not do so, greatly simplifying the design and operation of the system.

A set of lists 110 may be used to list unallocated blocks 106 of a particular size in number of records. As used herein, the phrase “a block of size J” refers to a block consisting of J contiguous records. For example, a block of size 10 is a block consisting of 10 contiguous records. Thus, the set of lists 110 may include a list of all unallocated blocks of size 1, a list of all unallocated blocks of size 2, and so on. In the embodiment illustrated in FIG. 1, each list of blocks of a particular size may be implemented as a linked list, and the set of lists 110 may be implemented as an array of pointers to top of each linked list. In alternative embodiments the set of lists 110 may be implemented by using arrays of arrays, lists of lists, lists of arrays, or other data structures known in the art.

System 100 may include an allocation module 112 for allocating and de-allocating portions of memory 102. During allocation of memory, allocation module 112 uses lists 110 to find an unallocated block of the smallest size that is equal to or greater than the size requested. During de-allocation of previously allocated memory, allocation module 112 uses allocation map 108 to determine whether the deallocated block can be combined with contiguous unallocated records to form a larger unallocated block. Using the example above, a deallocated block of size X that is contiguous to unallocated memory of size Y records could be combined and added to the list of unallocated blocks of size X+Y.

In one embodiment, allocation map 108, lists 110, and allocation module 112 may be components of a memory manager 114 that handles allocation and deallocation of portions of memory 102. In alternative embodiments, allocation map 108, lists 110, and allocation module 112 may each reside in separate modules that interoperate together to perform the allocation and deallocation functions.

In one embodiment, the unallocated memory itself is used to store the linked lists, rather than using additional memory for storing the data structures that represent each element of the linked list, thus reducing the memory overhead required and therefore the cost of implementing the system. In the embodiment illustrated in FIG. 1, memory 102 includes Z number of records, record #0 through record #Z−1 . Lists 110 includes an array, freeList[ ], where element j of the array points to a list of blocks of size j+1. Thus, freeList[0 ] points to a list of blocks of size 1, freeList[1] points to a list of blocks of size 2, and so on, up to freeList[N−1], which contains lists of blocks of the maximum size that can be allocated and deallocated, and freeList[N], which may be used to list blocks of size larger than maximum size that can be allocated and deallocated. Alternative embodiments that maintain substantially the same information are also contemplated. For example, freeList[j] could be used to point to blocks of size j, where j=1 through maximum block size N, with freeList[0] used as a pointer to blocks larger than size N.

In the example illustrated in FIG. 1, freeList[0] points to “Block C”, a single unallocated record 104 located at record number (#) N+5 in memory 102. Record #N+5 is used to store one item in the linked list. Array element freeList[2] points to “Block B”, an unallocated block of size 3 that occupies three contiguous records, record #N+1 through record #N+3. Array element freeList[3] points to “Block A”, an unallocated block of size 4 that occupies four contiguous records, record # 2 through record # 5. Array element freeList[1] points to the top of a linked list of blocks of size 2. However, in the example illustrated in FIG. 1, there are no unallocated blocks of size 2, so array element freeList[1] may be empty or contain a NULL or other value to indicate that this linked list has no members, i.e., there are no unallocated blocks of this particular size currently available.

In one embodiment, each item in a linked list may include several fields, such as “PREV”, a pointer to the previous item in the list; “NEXT”, a pointer to the next item in the list; and “SIZE”, a field indicating the size of the unallocated block. The unallocated block may be terminated by a second SIZE field again indicating the size of the unallocated block. For a block of size 1, the second SIZE field will be in the same record as the first SIZE field. For a block of size>1, however, the second SIZE field may be by itself in the last record of the unallocated block, while the first SIZE field may be in the first record of the unallocated block. In the example embodiment illustrated in FIG. 1, record #2 in memory 102 is the first record of “Block A”, an unallocated block of size 4. The first SIZE field is part of record #2 while the last SIZE field is located in the last record of the block, record #5.

Locating the SIZE fields in both the first and last records of the unallocated block provides allocation module 112 a mechanism to determine or confirm the size of a contiguous unallocated block. For example, allocation module 112 may use allocation map 108 to determine that a recently unallocated block is contiguous to an unallocated record, i.e., a record with an address just below the first record of the deallocated block or just above the last record of the deallocated block. By looking for a SIZE field in the contiguous unallocated record(s), allocation module 112 may determine or confirm the size of the contiguous unallocated block(s).

In one embodiment, records 104 are not associated with a block until they are combined into a block 106 in response to an allocation request. Once that block is deallocated, the unallocated block is added to the list of unallocated blocks of that size. For example, if a block of five records is deallocated, that block of unallocated records is added to the list of unallocated blocks of size 5. In an alternative embodiment, all unallocated records are initially considered members of an unallocated block of size Z, where Z is the size of memory 102 in records 104, i.e., a block containing the entire memory. In this scenario, lists 110 may include a list of blocks of size Z, the list having at most just one entry. When a memory allocation request is received, a portion of the block of size Z is allocated in a chunk just big enough to satisfy the size requested. For example, in response to an allocation request for a memory of size X records, a block of X contiguous records may be allocated from the block of size Z. The single entry would be removed from the list of blocks of size Z and an entry would be added to the list of blocks of size (Z−X). Later, when the block of size X is deallocated, the unallocated block would be added to the list of unallocated blocks of size X, or, as will be described below in more detail, combined with some number (e.g., Y) of adjacent contiguous unallocated blocks, and added to a list of unallocated blocks of size (X+Y).

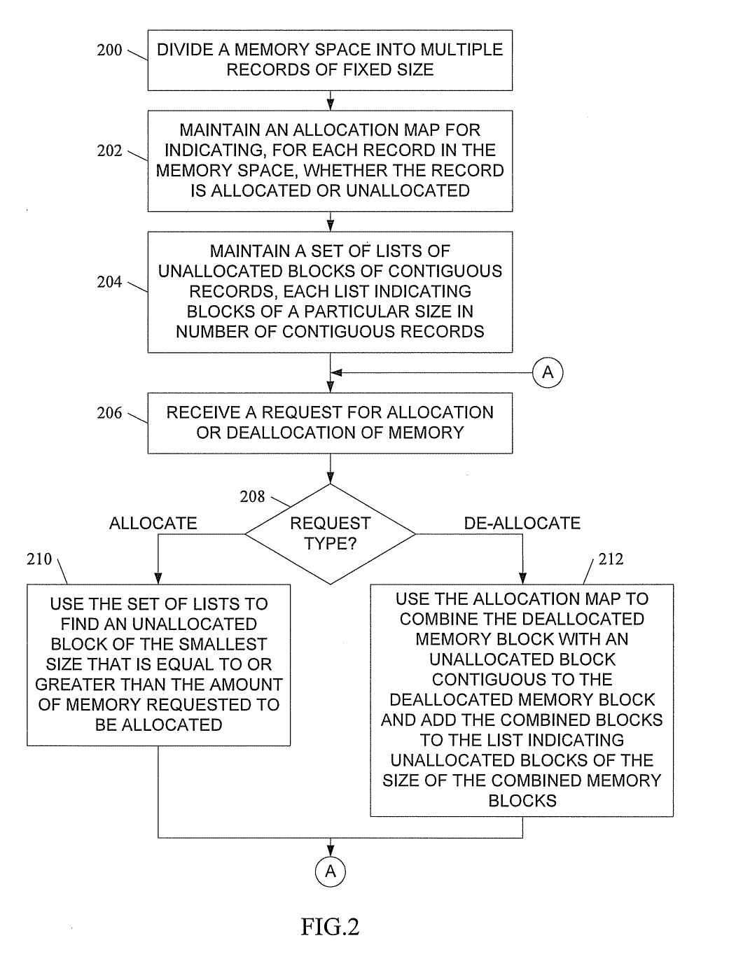

FIG. 2 is a flow chart illustrating an exemplary process for allocation and de-allocation of memory according to an embodiment of the subject matter described herein. The process will be described with reference to FIGS. 1 and 2.

At block 200, a memory space is divided into multiple records of fixed size. For example, memory 102 may be divided into multiple records 104.

At block 202, an allocation map, for indicating whether each record in the memory space is allocated or unallocated, is maintained. In FIG. 1, allocation map 108 may be implemented as a bitmap where each bit corresponds to one record 104 within memory 102, with each bit representing a record in order according to each record's position contiguous to other records. Thus, contiguous bits in allocation map 108 represent contiguous records 104 in memory 102. In one embodiment, a value of “1” in allocation map 108 indicates that the record is allocated and a value of “0” in allocation map 108 indicates that the record is unallocated. Allocation map 108 may be created and/or updated by either allocation module 112 or memory manager 114.

At block 204, a set of lists, each list indicating unallocated blocks of a particular size in number of records, is maintained. For example, lists 110 may be created and/or updated by either allocation module 112 or memory manager 114. In the embodiment illustrated in FIG. 2, lists 110 may include freeLists[ ], an array of linked lists. In the example scenario illustrated in FIG. 2, freeLists[0] points to Block C, the top of a linked list of blocks of size 1; freeLists[2] points to Block B, the top of a linked list of blocks of size 3; and freeLists[3] points to Block A, the top of a linked list of blocks of size 4. All other entries in freeList[ ], including freeLists[N], which points to the top of a linked list of blocks of size Z, point to empty lists.

At block 206, a request for allocation or de-allocation of memory is received. At block 208, it is determined whether the received request is for allocation or de-allocation of memory. If the request is for allocation of memory, control flow passes to block 210, and if the request is for de-allocation of memory, control flow passes to block 212. Upon completion of the respective requests, control flow returns to block 206 and remains there until the next request is received.

At block 210, a request for allocation of memory is processed. The set of linked lists 110 is used to find an unallocated block of the smallest size that is equal to or greater than the size requested. The following pseudo-code explains the allocation process:

```
pointer allocate(size_type size, const_pointer = 0)
{
    If a block of the requested size is available:
        Take it from the freeList_.
        Set the appropriate bitmap bits.
        Return block address.
    Else
        Look for the smallest available block that is
            larger than the requested block size.
        If found:
            Take it from the freeList_.
            Add remaining records to appropriate free list.
            Set the appropriate bitmap bits.
            Return block address.
        If not found:
            No memory blocks are available; out of memory
}
```

For example, upon receipt of a request for allocation of a block of size 4, allocation module 112 may access freeLists[3]; if freeLists[3] contains a pointer to a memory location, allocation module 112 may allocate the 4-record block of unallocated memory starting from the memory location pointed to by freeLists[3], and then remove the newly-allocated block of memory from the linked list of blocks of size 4.

In another example, upon receipt of a request for allocation of a block of size 2, allocation module 112 may access freeLists[1]; freeLists[1] may contain a pointer to a NULL memory location, indicating that there are no unallocated blocks of size 2. In this scenario, allocation module 112 may look for an unallocated block of the next larger size, by accessing freeLists[2], which lists unallocated blocks of size 3. If an unallocated block of size 3 is available, allocation module 112 may allocate the 3-record block of unallocated memory and remove the newly-allocated block of memory from the linked list of blocks of size 3. Alternatively, allocation module 112 may split the block of size 3 into a block of size 2, which is allocated to the entity that made the request for allocation of a block of size 2, and a block of size 1, which is added to the list of blocks of size 1. Allocation module 112 would update the information contained in lists 110 appropriately to reflect the changes in allocation, including adding entries to and removing entries from the appropriate lists.

At block 212, a request for de-allocation of memory is processed. Processing a de-allocation request includes using the allocation map to determine whether the deallocated block of size X records can be combined with contiguous unallocated memory of size Y records and added to the linked list indicating blocks of size X+Y records. The following pseudo-code explains the deallocation process:

```
void deallocate(pointer p, size_type n)
{
    Clear the corresponding bits in the bitset.
    Examine the bitset to determine if block needs to be
        merged to adjacent chunks.
    Merge contiguous chunks if needed.
    Insert final chunk into appropriate free list.
}
```

For example, the block of memory targeted for de-allocation may be one or more records 102 in size. Allocation map 108 is updated to indicate that the deallocated records 102 are now unallocated. For example, the bits representing the records of the deallocated block may be changed from “1” to “0”, indicating that those records are now unallocated.

Adjacent records, i.e., records contiguous to the unallocated records on either side of the unallocated records, are examined to determine whether they, too, are unallocated. In the embodiment illustrated in FIG. 1, the bits that are contiguous on either side to the bits within allocation map 108 that represent the records of the recently deallocated block bits are checked to see if they, too, indicate unallocated records. If any adjacent records 102 are also unallocated, the unallocated adjacent records may be combined with the newly unallocated records to form a larger block of records.

For example, in the embodiment illustrated in FIG. 1, if the block of size 1 located at record #N+4 in memory 102 was deallocated, allocation module 112 might first change the corresponding bit within allocation map 108, i.e., bit N+4, from “1” to “0” to indicate that record #N+4 is currently unallocated. Allocation module 112 may then begin the process of looking for other unallocated records contiguous to the recently deallocated block. For example, allocation module 112 may check allocation map 108 bits at location N+3: finding that this record is unallocated, allocation module 112 may look at bit N+2, N+1, and so on, until finding an allocated record at bit N. Allocation module 112 may then look for unallocated records contiguous to the other side of the recently deallocated record N+4, determining that bit N+5 is also unallocated but that bit N+6 is currently allocated and thus unavailable. At the conclusion of this process, allocation module 112 may determine that the recently deallocated block of size 1 located at record #N+4 may be combined with contiguous unallocated blocks to form a single unallocated block of size 5, containing records #N+1 through N+5 inclusive. The newly created unallocated block of size 5 would then be added to the list of unallocated blocks of size 5. Blocks that were combined to form the new block would be removed from their respective free lists of which they were a member. In this example, block B would be removed from the list of blocks of size 3 and block C would be removed from the list of blocks of size 1.

Thus, the allocation map 108 provides to allocation module 112 a very simple mechanism by which allocation module 112 can quickly combine contiguous unallocated records into larger unallocated blocks. As mentioned above, allocation module 112 may perform an additional check by looking for the SIZE fields in records #N+3 and N+5 and comparing the values written there with the information that allocation module 112 derived from allocation map 108. In the example above, allocation module 112 would expect to find a SIZE field in record #N+3 indicating a size=3, and a SIZE field in record #N+5 indicating a size=1. If allocation module 112 does not find these SIZE fields, or determines that the SIZE fields contain unexpected values, then allocation module 112 may perform additional error checking or analysis, generate an error message, flag a fault condition, or take other steps as appropriate. In some circumstances, allocation map 108 may indicate a number of contiguous unallocated records, which in actuality are divided into two or more unallocated blocks that may not have been previously merged into a larger block. Under these circumstances, the SIZE fields provide enough information for allocation module 112 to determine the boundaries of the unallocated blocks 106 within the group of unallocated records 104.

The methods, systems, and computer readable media for memory allocation and deallocation described herein are particularly suitable for use by a ranged indexed database (RIDB), disclosed in a commonly-assigned U.S. Provisional Patent Application No. 60/765,644, entitled “Methods, Systems, and Computer Program Products for Indexing, Validating, and Consolidating a Database Indexed by Range-Bound Numeric Data”, filed on Feb. 6, 2006, the disclosure of which is incorporated by reference herein in its entirety. As used herein, the term “RIDB container” refers to an entity that contains memory and implements an RIDB algorithm for allocation, deallocation, and use of the memory. In one implementation, one characteristic of an RIDB container is that the RIDB container asks for discrete blocks of memory of size S number of records, and, upon allocation of a block of size S, frees a block of memory of size S−1. Memory fragmentation may be reduced or minimized by detecting when a just-freed memory block is located next to another free block. The adjacent blocks may then be combined into a larger block, which is moved to the appropriate free list to be allocated when needed.

The RIDB algorithm efficiently stores homogeneous records of type T, and it follows a very specific pattern of memory allocation and deallocation. RIDB is based on ranged indices. It stores its Ts into many separate containers. In order to reduce memory waste and to increase storage efficiency, these containers request memory for more than one T at a time. Each container may store a maximum of MaxNumOfTs objects of type T. Thus, in one embodiment, the maximum size of a block 106 is N number of records, where N is the number of records sufficient to store MaxNumOfTs objects.

The first time a container needs memory, it asks for a record 104, or more accurately, a block 106 of size 1 record. When it has used all of this memory and it needs more, it asks for a block 106 of size 2 records. It copies the data from the old 1 record block into the first record of the new 2 record block, and it deallocates the first 1 record block. When the second record block is full and more memory is needed it, it requests a block 106 of size 3 records. It then copies the data from the record block of size 2 into the first 2 records of the new record block of size 3, and so on. When an allocated block 106 is no longer needed, the container will deallocate the block and thus make it available for subsequent allocation. In one embodiment, an RIDB container will respond to a request for allocation of memory by first looking for a block 106 of the requested size S, and if one is not available, look for blocks 106 of successively larger sizes (e.g., S+1, S+2, and so on) until it either finds a block that it can use or determines that no blocks are available.

By seeking a block 106 with the minimum size necessary to satisfy the request, and by actively joining deallocated blocks with contiguous unallocated blocks and adding the combined block so created to the appropriate list, an RIDB container that implements the algorithm or method described herein efficiently utilizes available memory and minimizes memory fragmentation.

As used herein, a memory block is “fragmented” if the block size is smaller than the largest block size that can be requested, i.e., if the block size is less than N. By this definition, the amount of memory 102 that is considered fragmented may be calculated by adding the records forming part of any block in freeList[0] through freeList[N−2]. An RIDB container implementing the methods and algorithms described above may reduce fragmentation in two ways. First, during the allocation process, the RIDB container attempts to serve an allocation request with a fragmented block first. In addition, it attempts to serve the request with a fragmented block of the exact requested size first, and only if it doesn't find one, does it start looking for larger blocks to serve the request. Similarly, only when it doesn't find a fragmented block to serve the request, does it use unfragmented memory chunks. Second, the RIDB container reduces fragmentation by merging smaller adjacent free memory chunks into a single large one. This memory collection technique is the last step in the deallocation process, and it consists on the examination of the bitmap pattern to determine if the record block being freed needs to be joined with an adjacent free chunk. To achieve this efficiently, the RIDB container uses the allocation bitmap 108 and the sizes at the head and the tail of memory chunks. The following pseudo-code explains the examination of the bitmap pattern:

```
if (bit before first Record Block bit is set) {
    if (prevSize < n+1) {
        getPrevRecordBlockOutOfItsCurrentFreeList( );
    }
    JoinThe2ChunksByChangingTheSize( );
}
if (bit after last Record Block bit is set) {
    getAfterChunkOutOfItsFreeList( );
    joinThe2Chunks( );
}
if (chunk not on a freeList) {
    addItToAppropriateFreeList( );
}
```

The allocation and deallocation performance is O(1), constant, and the memory overhead is O(Z) bits, due to the need for an allocation map 108 having a bit for each record 104 contained within memory 102. Filling a memory block completely before requesting any other produces approximately 0% fragmentation. This is achieved by inserting data in ascending or descending order into a RIDB container.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for allocation and de-allocation of memory, the method comprising:
dividing a memory space into a plurality of records of fixed size;
maintaining an allocation map for indicating, for each record in the memory space, whether the record is allocated or unallocated;
maintaining a set of lists of unallocated blocks, wherein a block is a group of contiguous records, wherein the size of a block is the number of contiguous records in the block, and wherein each list lists unallocated blocks of a particular size; and
processing requests for allocation and de-allocation of memory, wherein processing a request for memory allocation includes using the set of lists to find an unallocated block of the smallest size that is equal to or greater than the amount of memory requested to be allocated, and wherein processing a request for memory de-allocation includes using the allocation map to combine the deallocated memory block with an unallocated block contiguous to the deallocated memory block and add the combined blocks to the list indicating unallocated blocks of the size of the combined memory blocks.

2. The method of claim 1 comprising removing the deallocated memory block of the first size from the list indicating unallocated blocks of the first size and removing the unallocated memory block of the second size from the list indicating unallocated blocks of the second size.

3. The method of claim 1 wherein the set of lists comprise a set of linked lists.

4. A system for allocation and de-allocation of memory, the system comprising:
a memory organized into a plurality of records of fixed size;
an allocation map for indicating, for each record in the memory, whether the record is allocated or unallocated;
a set of lists of unallocated blocks, wherein a block is a group of contiguous records, wherein the size of a block is the number of contiguous records in the block, and wherein each list lists unallocated blocks of a particular size; and
an allocation module for allocating and de-allocating memory, wherein allocating memory includes using the set of lists to find an unallocated block of the smallest size that is equal to or greater than the amount of memory requested, and wherein de-allocating memory includes using the allocation map to combine the deallocated memory block of a first size with an unallocated block of a second size and contiguous to the deallocated memory block to form an unallocated block of a third size and adding the unallocated block of the third size to the list indicating unallocated blocks of the third size.

5. The system of claim 3 wherein the set of lists comprise a set of linked lists.

6. A memory manager for allocating and de-allocating memory, the memory manager comprising:
an allocation map for indicating, for each record in a memory that is organized into records of a fixed size, whether the record is allocated or unallocated;
a set of lists for listing unallocated blocks of particular sizes, wherein a block is a group of contiguous records and wherein the size of the block is the number of contiguous records in the block; and
an allocation module for allocating and de-allocating memory, wherein allocation includes using the set of lists to find an unallocated block of the smallest size that is equal to or greater than the size requested, and wherein de-allocation includes using the allocation map to combine the deallocated memory block with an unallocated block contiguous to the deallocated memory block and add the combined blocks to the list indicating unallocated blocks of the size of the combined memory blocks.

7. The memory manager of claim 5 wherein the set of lists comprise a set of linked lists.

8. A computer readable medium having stored thereon computer-executable instructions that when executed by the processor of a computer perform steps comprising:
dividing a memory space into a plurality of records of fixed size;
maintaining an allocation map for indicating, for each record in the memory space, whether the record is allocated or unallocated;
organizing contiguous records into blocks, wherein the size of the block is the number of contiguous records in the block;
maintaining a set of lists for listing unallocated blocks of particular sizes; and
processing requests for allocation and de-allocation of memory, wherein processing a memory allocation request includes using the set of lists to find an unallocated block of the smallest size that is equal to or greater than the amount of memory requested to be allocated, and wherein processing a memory de-allocation request includes using the allocation map to combine the deallocated memory block with an unallocated block contiguous to the deallocated memory block and add the combined blocks to the list indicating unallocated blocks of the size of the combined memory blocks.
